(19) United States
(12) Patent Application Publication
(10) Pub. No.: US 2005/0249108 A1
(43) Pub. Date: Nov. 10, 2005

(54) Record carrier with multiple coupling elements

(75) Inventors: Alphons Antonius Bruekers, Weert (NL); Antonius Hermanus Akkermans, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/529,354

(22) PCT Filed: Sep. 22, 2003
(86) PCT No.: PCT/IB03/04077

§ 371 Date: Mar. 25, 2005

(30) Foreign Application Priority Data
Sep. 30, 2002 (EP) 021023973

(51) Int. Cl. G11B 15/64; G11B 17/32

(52) U.S. Cl. 369/300

(57) ABSTRACT

The invention relates to a record carrier (1) like a CD-RW+ or a DVD supporting an improved handling and, in particular, an improved access control to information stored on the record carrier (1) by supplying an additional information source. The record carrier (1) has a first area (3) for storing a first kind of information and further has multiple second areas (4.1, . . . , 4.8) each designed for comprising a coupling element to a device for reading and/or writing the record carrier (1), the distribution of the coupling elements on the record carrier (1) encoding a third kind of information, e.g. a regional code indicating the geographical regions the record carrier (1) is valid. Storage media storing information of second kinds may supplement the coupling elements and a coupling element and a storage medium may be integrated into a chip. Making the coupling elements detachable from the record carrier (1) results in an easy way of modifying the third kind of information on a finished record carrier (1).

The invention relates to a record carrier, in particular to a record carrier storing access-controlled, in particular copy-protected, information. Examples of such record carriers are mainly Audio CDs, CD-ROMs, CD-Rs, CD-RWs, DVDs etc., but the invention is equally applicable to other record carriers as well, as e.g. magnetic tapes, diskettes, and hard disks.

Record carriers such as CDs or DVDs are nowadays a mass product used e.g. for distributing audio and video content for entertainment purposes and to supply software and computer games. Moreover, certain kinds of these media such as the CD-R and the CD-RW+ are once or several times recordable e.g. by using a CD burner. They are therefore also usable for short-term backup as well as for long-term archiving purposes. Moreover, the increasing storage capacities of these devices extend their applicability even further.

On the other hand, the existence of these easy to handle and durable recordable media in connection with the digital representation 6f the media contents opened an easy way of taking one-to-one copies of copyrighted CDs, which nowadays presents a major commercial problem for the content industries. Besides this copy-protection problem the large storage capacities of these record carriers call for methods supporting the access to and the preferably personalized presentation of the information being stored on the record carriers.

Accordingly, several methods for these purposes have been proposed in the state of the art. These methods range from encrypting the content of a record carrier and preventing an easy copying of the decrypting information to access-control and personalization structures on the record carriers as well as on the corresponding reading and/or writing devices for the record carriers. E.g., among others it was proposed to use password protection, to structure the record carrier in different parts each part possessing its own access rights, and to use unique identifiers for record carriers in connection with a revocation list of the identifiers of counterfeit media. In that, the access control and/or personalization themselves might be performed by structures on the record carrier, by the reading and/or writing device for the record carrier, or in cooperation between both.

U.S. Pat. No. 6,044,046 A proposes to use a chip being physically integrated within the record carrier as a device carrying the access-control and/or personalization structures for the record carrier. This allows downward compatibility with e.g. traditional CDs and renders the record carrier with built-in chip as easy to handle as a record carrier itself. Furthermore, U.S. Pat No. 6,044,046 A discloses the communication interfaces of the chip and of a corresponding device for reading and/or writing the record carrier with built-in chip. In particular, a solution is described for allowing the reading and/or writing device simultaneous access to the record carrier and the built-in chip. For the full description of these and related issues the contents of U.S. Pat. No. 6,044,046 A are herewith incorporated into this application by reference.

U.S. Pat. No. 6,044,046 A also mentions the necessity of establishing a high enough data transfer rate between the chip and the reading and/or writing device for enabling a smooth operation of the record carrier in the reading and/or writing device. If e.g. an optical path is used for communicating between the chip and reading and/or writing device the data bits on this path can only flow when a respective coupling element on the record carrier is in sight of the corresponding element of the reader/writer. To enable high enough data rates U.S. Pat. No. 6,044,046 A therefore proposes to use a large coupling element on the record carrier, e.g. a circular one being in continuous sight of the reader/writer's element, and/or to use multiple coupling elements distributed over the area of the record carrier seen by the reader/writer's element. Instead of making the coupling element large or use a multiplicity of them U.S. Pat. No. 6,044,046 A also foresees the possibility of a single small coupling element being coupled to an appropriate large or a multiplicity of auxiliary elements serving as transmitter and/or receiver.

While the built-in chip concept of U.S. Pat. No. 6,044,046 A offers a quite flexible solution to access control and information personalization of a record carrier such chips and the structure of its coupling and/or auxiliary elements and their connections are already somewhat complex and might e.g. be regarded as too costly for storing small amounts of information as e.g. a regional code encoding in what geographical regions a record carrier is valid. Moreover, modifying the access-control information after finishing the record carrier, e.g. after acquiring new access rights, requires re-programming of the chip. But, allowing a user to re-program the access rights on the chip at his or her premises may compromise the copy protection of the record carrier.

Therefore, it is an object of the invention to provide a record carrier and a corresponding device for reading and/or writing it that provides a simple and flexible way of encoding small to medium amounts of handling and, in particular, access-control information for the record carrier. A further object of the invention is to allow for a simple way of adding, deleting, and/or changing this information after production of the record carrier.

These objects are accomplished by a record carrier having a first area for storing a first kind of information and further having multiple second areas each designed for comprising a coupling element to a device for reading and/or writing the record carrier, the distribution of the coupling elements on the record carrier encoding a third kind of information,

and by a device for reading and/or writing such a record carrier, wherein the device is designed for sensing the distribution of the coupling elements on the record carrier.

Together, the record carrier and the device for reading and/or writing it form a system for handling information and in particular for supporting access control to information according to the invention. Moreover, the invention provides a method for handling an inventive record carrier and in particular for reading and/or writing such a record carrier, the method comprising the steps of sensing and decoding the third kind of information, and handling the record carrier in dependence on the third kind of information, in particular, reading and/or writing all or part of the first kind of information in dependence on the third kind of information.

Encoding the record carrier's handling information by the distribution of the coupling elements and observing that a coupling element may be implemented by very simple circuitry as e.g. just a few turns of an inductive coil achieves the object of a simple and cheap embodiment. Employing a large enough number of coupling elements and using their relative radial and angular positions on the record carrier for encoding provides enough capacity for small and medium amounts of handling information. Such information may e.g. comprise a regional code determining in which geographical areas the record carrier is valid, an encoding for the standards the record carrier complies to, and an indication which side is up after having inserted the record carrier in the reader/writer.

Regional codes e.g. are used to restrict the usage of a record carrier to specific regions only, e.g. a DVD might only have been released in the U.S., thus, readers sold on the European market should not play such a DVD, which is accomplished letting the reader check the DVD's regional code. In general, the readers/writers will use the handling information e.g. control their access to the record carrier and to display corresponding information to the user, e.g. that he inserted the record carrier upside down or that this record carrier does not comply to the standards supported by the reader/writer. Of course, the information of the third kind encoded by the distribution of the coupling elements need not be handling information only but might be any other information, too.

As already said the coupling elements might be extremely simply, their minimum requirement just being that they are able to indicate their existence to the reader/writer. Thus, e.g., if the coupling is electromagnetic, a coupling element might just be an inductive coil, e.g. a few turns of a wire in a spiral pattern, or, if the coupling is optical, the coupling element might just consist of some suitable material having a different reflectance than the surrounding carrier material. Thus, the term coupling element is used here in its most general sense, and, as compared to its use in U.S. Pat. No. 6,044,046 A, encompasses not only the coupling elements of this document but also the auxiliary elements mentioned there.

In its simplest form there is no need for interconnecting the coupling elements. But, of course, the coupling elements might be interconnected with more powerful other building blocks as e.g. storage media storing information of a second kind, e.g. decryption information for the payload data, typically songs and/or videos and/or computer games, being stored in encrypted form as the information of the first kind on the first area of the record carrier. Moreover, a coupling element and a storage medium might be integrated into a chip rendering, or, as in U.S. Pat. No. 6,044,046 A, a chip might be connected to multiple coupling elements. In this last embodiment one arrives at the solution of U.S. Pat. No. 6,044,046 A with the additional feature of distributing the coupling elements in a deliberate fashion to encode the information of the third kind, thereby obtaining the advantage of supplying an additional source of information without having to spend additional elements.

Allowing the coupling elements to be attached or detached from the second areas provides a simple way of adding, deleting, or replacing such elements, thus changing the distribution pattern in a mere “mechanical” way. For that, the coupling elements might e.g. be produced each on a plastic film, which is simply glued to a correspondingly prepared position of the record carrier much like a sticker, or, if the coupling element are provided in a housing, this housing might be snapped into a corresponding pit being milled into a second area, the housing being fixed by using some spring mechanism. The coupling elements might be traded separately from the record carriers and, in case of chips, might e.g. be programmed or re-programmed using equipment only being available in specialty shops, which would yield an additional level of security against counterfeiting such chips. Accordingly, the invention also relates to such coupling elements and in particular to chips being designed to be attached to an inventive record carrier.

In the same way, the invention also encompasses record carriers whose multiple second areas are devoid of any coupling element or chip but which are designed or prepared for having such coupling elements being attached. Such designs might e.g. consist in pits being milled in the second areas, maybe assisted by some spring mechanism, but might equally well just consist in markings of the second areas on the record carrier, a coupling element being produced on a plastic film, which is simply to be glued to the marking of a second area much like a sticker. Such attaching of coupling elements to the second areas of an inventive record carrier may further be simplified for a user by arranging several coupling elements on a single carrier, e.g. a plastic film, which is attached to the second areas of the record carrier as a single piece. Accordingly, the invention also relates to such carrier devices for coupling elements.

Embodying an inventive record carrier and its reading and/or writing device in a manner that the record carrier's first area can be read and/or written in parallel to sensing the distribution of the coupling elements on the record carrier offers the advantage that the reading and/or writing device can handle the data encoded on the two areas independently of each other, i.e. the two data streams can be processed without disturbing each other. This offers e.g. the possibility to continuously check, e.g. at regular or irregular intervals in time, the authenticity and/or integrity of the record carrier, thus enhancing the access control to the record carrier. E.g., assume that the distribution of the coupling elements specifies a regional code. If the reader/writer verifies this regional code only once when the record carrier is inserted in the device a hacker may betray the device by supplying at this point a faked regional code using specialized hacked equipment. This kind of attack gets much more involved if the reading and/or writing device verifies the regional code several times at e.g. irregular time intervals.

While a reader/writer may perform the sensing of the distribution of the coupling elements on the record carrier as well as the decoding of the distribution's meaning these tasks may as well be distributed between several devices. E.g. a simple reader/writer to be used as a peripheral to a personal computer may just do the sensing to transfer the distribution information to the PC where the application program takes the task of decoding.

Of course, as is obvious to one skilled in the art, one may combine the above-described measures for obtaining an even improved handling of an inventive record carrier. E.g., one may advantageously use removable chips integrating a coupling element with a storage medium as well as a processor. These chips may then be traded as separate devices and also may be programmed or re-programmed at specialty shops.

These and further aspects and advantages of the invention will be further illustrated by the embodiments and, in particular, by the description of the attached figures.

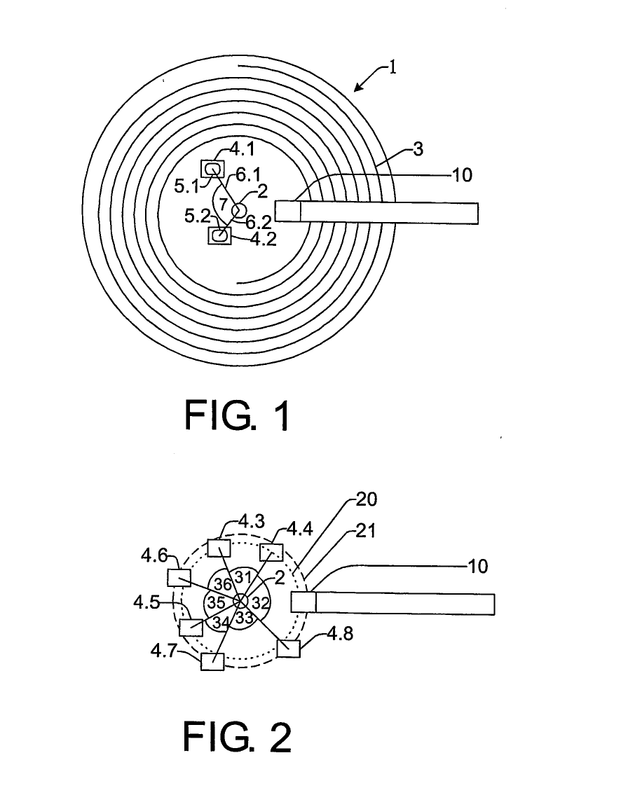

FIG. 1 shows diagrammatically an inventive record carrier and a read/write head of an inventive reader/writer.

FIG. 2 shows diagrammatically a distribution of the second areas on two circles on an inventive record carrier and a read/write head of an inventive reader/writer.

FIG. 1 shows diagrammatically an inventive record carrier 1 in the form of a disk and a read/write head 10 of an inventive reader/writer. The record carrier 1 has a central aperture 2 and a track 3. The track 3 is arranged in a spiral or concentric pattern and comprises a first area for storing information of a first kind, e.g. payload data like songs and/or videos and/or computer games or personal information of a user. Two second areas 4.1 and 4.2 for storing information of a second kind, e.g. access control and/or personalization information, are also present on the record carrier 1. The second areas 4.1 and 4.2 each comprise a chip integrating a storage medium and a coupling element 5.1 respectively 5.2, e.g. an inductive coil or an LED and a photodiode, for communicating with the corresponding read/write head 10 of a device for reading and/or writing the record carrier 1. For more details on the general structure of the record carrier 1 and its communication means with the device for reading and/or writing it reference is again made to U.S. Pat. No. 6,044,046 A.

The distribution of the coupling elements 5.1 and 5.2 on the record carrier 1 is given by their radial distances from the central aperture 2, i.e. the lengths of the lines 6.1 and 6.2, and by the angle 7 between these two lines 6.1 and 6.2. This information e.g. is sufficient to indicate the orientation of the record carrier 1 as it is inserted into the reader/writer.

FIG. 2 shows diagrammatically a distribution of six second areas 4.3 through 4.8, being equipped with coupling elements not shown in the figure, on an inventive record carrier 1 and a read/write head 10 of an inventive reader/writer. The second areas 4.3 through 4.8 are arranged on two concentric circles 20 and 21 centered on the central aperture 2 of the record carrier 1, i.e. the second areas 4.3, 4.4, and 4.5 lie on the inner circle 20 and second areas 4.6, 4.7, and 4.8 on the outer circle 21. Besides their position on the circles 20 or 21, the angular position of the second areas 4.3 through 4.8 on the record carrier is given by the six angles 31 through 36 formed by the connection lines of the second areas 4.3 through 4.8 with the central aperture 2.

During a revolution of the record carrier the read/write head 10 of the reader/writer will sense the relative position of the second areas 4.3 through 4.8, i.e. their position on the circles 20 or 21 and their angular positions 31 through 36. For sensing the position on the circles the read/write head 10 might e.g. be constructed as being direction dependent. For sensing the angle between two successive second areas, e.g. the angle 31 between the second areas 4.3 and 4.4 if the disk rotates clock-wise, the reader/writer may measure the time between “seeing” area 4.3 and “seeing” area 4.4, i.e. by measuring the time span between the middle points of the time intervals when being in contact with area 4.3 respectively 4.4. As the revolution speed of the record carrier typically will vary over time, of course, these absolute time spans have to be related to the duration of one revolution. Detecting that a revolution finished can e.g. be performed by giving one second area a code allowing it to be identified or by detecting the periodic re-occurrence of the second areas distribution (provided the distribution pattern avoids any periodicity within one revolution).

Thus, the read/write head 10 is able to sense the second areas' distribution pattern, which encodes a third kind of information as e.g. a regional code indicating in which geographical regions the record carrier is valid, and/or which standards the record carrier complies to, and/or if the record carrier has been inserted upside-down. This last task of detecting the orientation the record carrier has been inserted can e.g. also be performed by using two second areas being on a circle at an angle to each other different from 180° and supplying one of it with a storage medium equipped with an identification code or by using three second areas on a circle at non-equal angles to each other.

Instead of using the different radial positions of the second areas, i.e. their locations on circles 20 or 21, for encoding a third kind of information, such position also might be used to support different kinds of readers/writers having their read/write heads at different radial positions. In this case, only the angular distribution 31 through 36 is used for encoding the third kind of information.

For addressing the multiple second areas in the communication between record carrier and reader/writer explicit addresses for the second areas might be used, which are communicated by the second areas at the beginning of each communication to the reader/writer. Of course, usage of such codes requires the second areas to each comprise a storage medium for the code. As an alternative, usage of an aperiodic pattern avoids this requirement as described above. After one revolution of the record carrier (or a few revolutions if the above described periodicity recognition is used) the reader/writer knows the succession of the second areas. At this point latest, instead of requiring an explicit address sending the reader/writer may identify the second areas simply by their succession.

1. A record carrier (1) having a first area (3) for storing a first kind of information and further having multiple second areas (4.1, . . . , 4.8) each designed for comprising a coupling element to a device for reading and/or writing the record carrier (1), the distribution of the coupling elements on the record carrier (1) encoding a third kind of information.

2. A record carrier (1) as claimed in claim 1, characterized in that the distribution of the coupling elements on the record carrier (1) encodes
a regional code indicating a geographical region the record carrier (1) is valid for, and/or
which standards the record carrier (1) complies to, and/or
the orientation in which the record carrier (1) has been inserted into a device for reading and/or writing the record carrier (1).

3. A record carrier (1) as claimed in claim 1, characterized in that at least one of the second areas (4.1, . . . , 4.8) is designed for detaching and/or attaching a coupling element to it.

4. A record carrier (1) as claimed in claim 1, characterized in that at least one of the second areas (4.1, . . . , 4.8) is designed for comprising a storage medium for storing a second kind of information, the coupling element of the second area (4.1, . . . , 4.8) serving for coupling the storage medium to a device for reading and/or writing the record carrier (1).

5. A record carrier (1) as claimed in claim 4, characterized in that the second area (4.1, . . . , 4.8) is designed for comprising a chip integrating the storage medium and the coupling element of that second area (4.1, . . . , 4.8).

6. A coupling element being designed for being attached to a second area (4.1, . . . , 4.8) of a record carrier (1) as claimed in claim 1.

7. A carrier device, in particular a plastic film, with a coupling element as claimed in claim 6.

8. A device for reading and/or writing a record carrier (1) as claimed in claim 1, wherein the device is designed for sensing the distribution of the coupling elements on the record carrier (1).

9. A device for reading and/or writing as claimed in claim 8, characterized in that the device is designed for accessing the first area (3) and sensing the distribution of the coupling elements on the record carrier (1) in parallel.

10. A device for reading and/or writing as claimed in claim 8, characterized in that the device is designed for decoding the third kind of information being encoded in the distribution of the coupling elements on the record carrier (1).

11. A system for handling information, in particular for supporting access control to information, the system comprising a device as claimed in claim 8 and a record carrier (1) as claimed in claim 1 carrying the information.

12. A method for handling, in particular for reading and/or writing, a record carrier (1) as claimed in claim 1, with the steps:
sensing and decoding the third kind of information, and
handling the record carrier (1) in dependence on the third kind of information, in particular, reading and/or writing all or part of the first kind of information in dependence on the third kind of information.
